(19) United States
(12) Patent Application Publication
(10) Pub. No.: US 2010/0309097 A1
(43) Pub. Date: Dec. 9, 2010

(54) HEAD MOUNTED 3D DISPLAY

(76) Inventors: Roni Raviv, Nes Ziona (IL); Liran Ganor, Even- Yehuda (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 12/477,992

(22) Filed: Jun. 4, 2009

(51) Int. Cl. G09G 5/00

(52) U.S. Cl. 345/8

(57) ABSTRACT

A head mounted display (HMD) including a display screen attached to a housing and aligned to be in a line of sight of a first eye of a user, an optics module disposed in the housing, for generating an image and projecting a beam of the image on the display screen, and a non-display screen attached to the housing and aligned to be in a line of sight of a second eye of the user, wherein the image displayed on the display screen is displayed at a virtual display distance different than a distance at which an image of the non-display screen is perceived.

### FIELD OF THE INVENTION

The present invention relates generally to head mounted displays, and particularly to a see-through augmented reality head mounted display which gives the effect of a three-dimensional virtual image superimposed on the real world.

### BACKGROUND OF THE INVENTION

A head mounted display system is a display system that is mounted on a user's head and projects a virtual image for one or both eyes. Head mounted displays have many uses, such as in games, just to name one. A commonly used method to provide a three-dimensional virtual image is to project two images generated from different perspectives to each eye to mimic a real situational 3D screen. The displays require two image screens with separate images. The 3D effect is sensed by the brain by combining several clues, including the difference (parallax) between the two images, the focus of the image, and other clues such as known size, shading, perspective, etc. A problem may occur with displays of virtual images in augmented reality systems. The problem is that of “virtual reality” sickness, which can be experienced by users of video games or flight simulators. It is believed that the source of the problem is a sensory mismatch that causes motion sickness, which is the sensation the brain encounters when it perceives that the body is in motion (when in fact there is no motion), and it attempts to correct bodily posture to counteract the perceived physical sensation. Another example of sensory mismatch occurs when the eye perceives motion, but no motion actually occurs. This sensation is magnified by the generation of virtual images focused at a different distance then the parallax between both eyes (the shift between the left and right images).

### SUMMARY OF THE INVENTION

The present invention seeks to provide a head mounted display (HMD) that augments reality (the see-through effect), as is described more in detail hereinbelow. The HMD provides a three-dimensional sensation wherein the foreground virtual image is seen by one eye and the real surrounding is seen by both eyes, thereby reducing the motion sickness and the fatigue generated by two image 3D displays of the prior art.

The “see-through” effect combines the virtual image at one focus and the real world perceived by each eye, with each eye having a slightly different view of the reality perception. Both eyes have see-through screens to provide similar surroundings (providing a reality view with its 3D information), thereby avoiding a mismatch between the eyes. One cannot project a virtual image on one eye and have the surroundings seen by both eyes when there is a significant difference in brightness between the two screens (e.g., 20% difference in brightness).

There is thus provided in accordance with an embodiment of the present invention a head mounted display (HMD) including a display screen attached to a housing and aligned to be in a line of sight of a first eye of a user, an optics module disposed in the housing, for generating an image and projecting a beam of the image on the display screen, and a non-display screen attached to the housing and aligned to be in a line of sight of a second eye of the user, wherein the image displayed on the display screen is displayed at a virtual display distance different than a distance at which an image of the non-display screen is perceived. The display screen displays the image superimposed upon the image of the non-display screen.

The display screen and the non-display screen may have similar light transmissivity. The display screen may have a greater reflectivity than the non-display screen. The non-display screen may be darker than the display screen. The non-display screen may have similar or different optical reflectivity and transmission as the display screen.

In accordance with an embodiment of the present invention a position of the beam with respect to the optics module to the display screen is adjustable so as to adjust the virtual distance at which the image is seen.

In accordance with an embodiment of the present invention the optics module is movably mounted in the housing, such that a distance of the optics module to the display screen is adjustable.

In accordance with an embodiment of the present invention the display screen is pivotally mounted to the housing by means of a hinge.

In accordance with an embodiment of the present invention a sensor (e.g., camera) is in communication with the optics module, the sensor operative to sense movement of the user to provide the user with a feeling of objects moving across and off the display screen.

### BRIEF DESCRIPTION OF THE DRAWINGS

The present invention will be understood and appreciated more fully from the following detailed description taken in conjunction with the drawings in which:

FIGS. 1A-C are simplified pictorial illustrations of a head mounted display (HMD), constructed and operative in accordance with an embodiment of the present invention;

FIG. 2 is a simplified pictorial illustration of the position of the images displayed on the display screen of the HMD at a virtual display distance different than the distance at which the eye perceives an image of the non-display screen, in accordance with an embodiment of the present invention;

FIG. 3 is a simplified schematic illustration of the optical elements of the HMD and the relation of the projected image to the user's eye, in accordance with an embodiment of the present invention;

FIG. 4 is a simplified schematic illustration of a tri-chromatic optical projection system for the HMD, in accordance with an embodiment of the present invention;

FIGS. 5A and 5B are simplified pictorial illustrations of adjusting the imaginary distance depth of the HMD of FIG. 1, in accordance with an embodiment of the present invention;

FIGS. 6A and 6B are simplified pictorial illustrations of adjusting the display substrate of the HMD so as to move the displayed information to different areas of the field of view (FOV), in accordance with an embodiment of the present invention;

FIGS. 7A-7C are simplified pictorial illustrations of a tracking capability of the HMD, in accordance with a non-limiting embodiment of the present invention;

FIGS. 8A-8C are simplified pictorial illustrations of controllers for use with the HMD, in accordance with an embodiment of the present invention, FIG. 8A showing a tennis racket, FIG. 8B showing a steering wheel, and FIG. 8C showing a bat/stick/wand; and

FIGS. 9A-9F are simplified pictorial illustrations of a game which may be played with the HMD of the invention, in accordance with a non-limiting embodiment of the present invention.

### DETAILED DESCRIPTION OF EMBODIMENTS

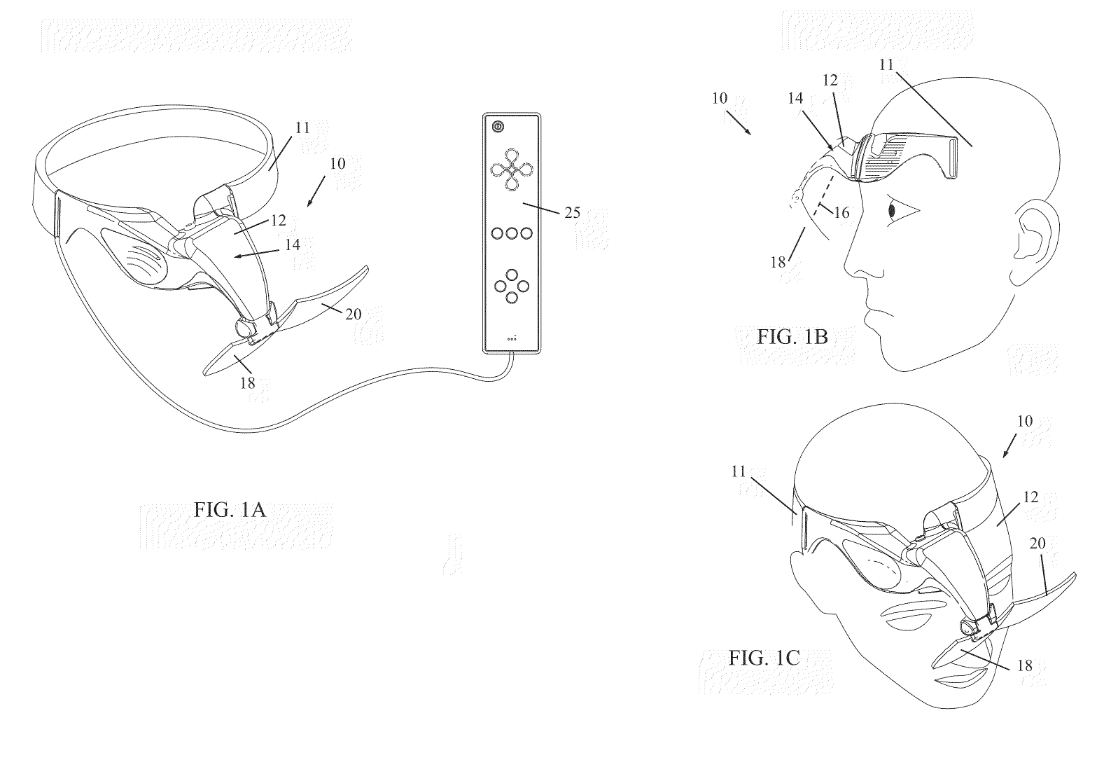

Reference is now made to FIGS. 1A-C, which illustrates a HMD 10, constructed and operative in accordance with a non-limiting embodiment of the present invention.

HMD 10 includes a headband 11 with a housing 12 mounted thereon, and an optics module 14 disposed in housing 12. Optics module 14 will be described more in detail below with reference to FIG. 3. Optics module 14 may include a computer-generated imagery (CGI) system and suitable optical elements (lenses, mirrors, filters, LCD, OLED, etc.) for generating images and projecting a beam 16 of the images on a display substrate (also called display screen) 18 pivotally attached to housing 12. It is noted that optics module 14 may include the display screen; the module has the optical power capacity to generate the virtual image. It may be spheric or aspheric.

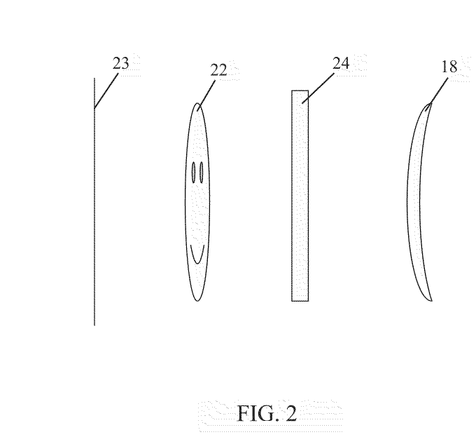

A non-display screen 20 is also pivotally attached to housing 12. The images 22 displayed on display screen 18 are displayed at a certain focal distance from HMD 10 (called the virtual display distance), different than the distance at which the eye perceives an image 24 of the non-display screen 20, as seen in FIG. 2. Non-display screen 20 may be darker than screen 18, such as gray or one of the basic RGB colors, or any other color or mixture of colors. Non-display screen 20 may have a similar or different optical reflectivity and transmission as screen 18. It is important to note that the non-display image is seen through both screens; both screens are mostly transparent and will transmit the surroundings to both eyes.

HMD 10 gives the user a feeling of a three-dimensional display for several reasons:

a. The display screen 18 is not opaque and thus lets the user see the virtual images 22 superimposed on the surrounding background 23, at a different distance from the surrounding background 23.

b. The user's eye perceives image 24 of the non-display screen 20 superimposed with images 22 of display screen 18 and at a different distance than images 22. The other eye also sees image 24 is through the display screen 18 (e.g., an object closer than the background, a hand held device, etc.) The user's eye/brain combines the images 22, image 24 and background 23 to provide depth perception and a 3D feeling. All 3D dimensional clues to the brain are present except for the two parallax images of the virtual object. The virtual objet is seen by one eye and its depth relative to all other 3D views is controlled by the virtual distance of the HMD by the controlled focus.

c. The images 22 of display screen 18 are rendered with color and shading, enhancing the 3D feeling.

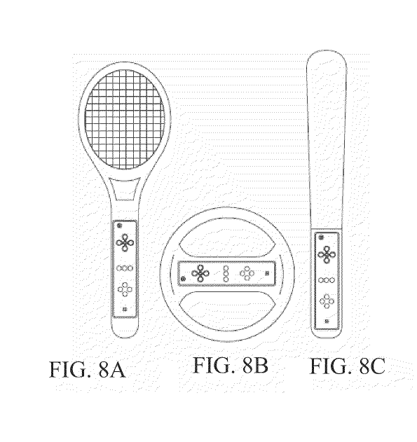

A controller 25 may be connected (wired or wireless connection) to the processor portion of optics module 14 for controlling various technical features and parameters of the images being displayed on display screen 18, and for controlling different aspects of the game being played or any other information and data to be processed and displayed. This controller can have various shapes, such as but not limited to, a tennis racket (FIG. 8A), steering wheel (FIG. 8B) or a bat/stick/wand (FIG. 8C), with various sensors (e.g., accelerometers, inertial sensors, 3D position sensors, etc.) to sense its dynamic position for interaction with the game.

Reference is now made to FIG. 3. In one embodiment, display substrate 18 is pivotally mounted to housing 12 by means of a hinge 28. Hinge 28 may be a friction hinge that permits adjusting the angular rotation of display substrate 18 to any desired angle. Alternatively, hinge 28 may have detents or stops that permit adjusting the angular rotation of display substrate 18 to one of many predetermined angles (e.g., audible clicks may be heard when rotating through the range of predetermined angles). Display screen 18 is pivotally mounted to an extension arm 30 of housing 12. Because display screen 18 is pivotally mounted to housing 12, display screen 18 can be folded away to instantaneously clear the field of view. As seen in FIGS. 6A-6B, the rotational orientation of display screen 18 of HMD 10 can be adjusted to move the displayed information to different areas of the field of view or completely outside the FOV.

Housing 12 may be constructed, without limitation, of a rigid plastic. Display screen 18 may be constructed, without limitation, of optical-grade injected-molded polycarbonate, which is very suitable for mass production. Thus display screen 18 may be a low-cost, mass-produced, injected-molded reflective lens, which may be aspheric for low image distortion and miniaturization. Display screen 18 may be transparent or semi-transparent, and may comprise a monochromatic transmissive substrate or may be coated with a thin film coating, such as a dichroic coating on a rear surface thereof. Multilayer thin film coatings may be used for optimal contrast and brightness on injected molded polycarbonate lenses in varying ambient light conditions. The reflectivity and transmissive properties of display screen 18 (and screen 20) may be engineered for the particular application. One of the preferred embodiments has a 60% transmissivity and 20% reflective coating on the inside of the view screen to enable full color display. The non-view screen also has 60% transmissivity and may or may not have a reflective coating.

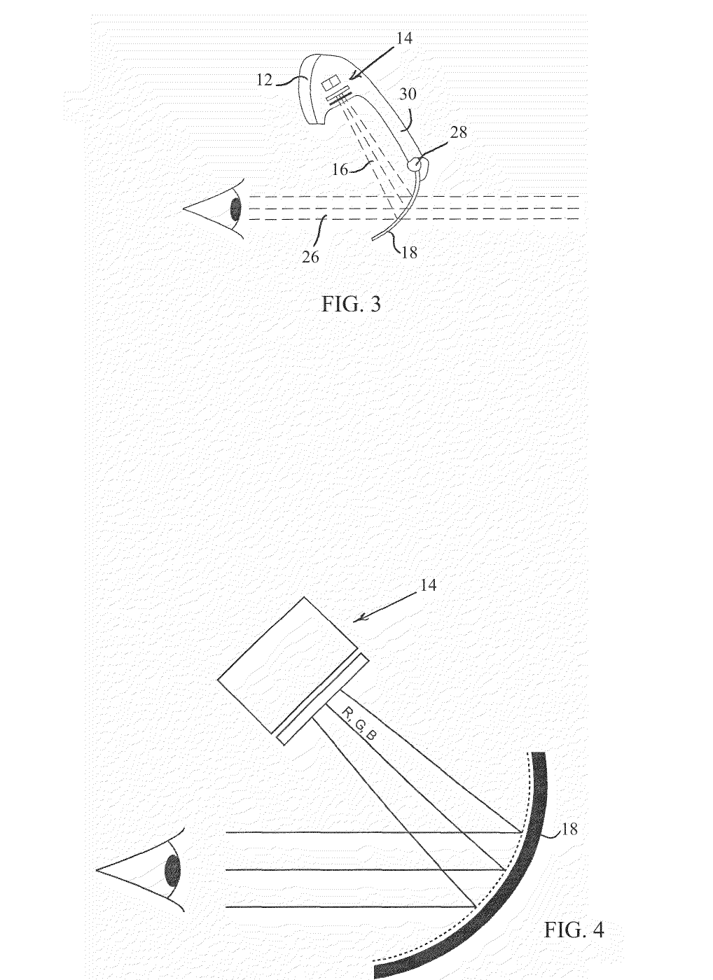

Referring to FIG. 4, it is seen that HMD 10 may be provided with two or three color optics (such as red and green, or red, green and blue). HMD 10 may be provided with different detachable display screens 18 having, for example, different colors or lens characteristics (smooth, Fresnel, holographic and others). Different types of coatings may be used, such as silver, for example.

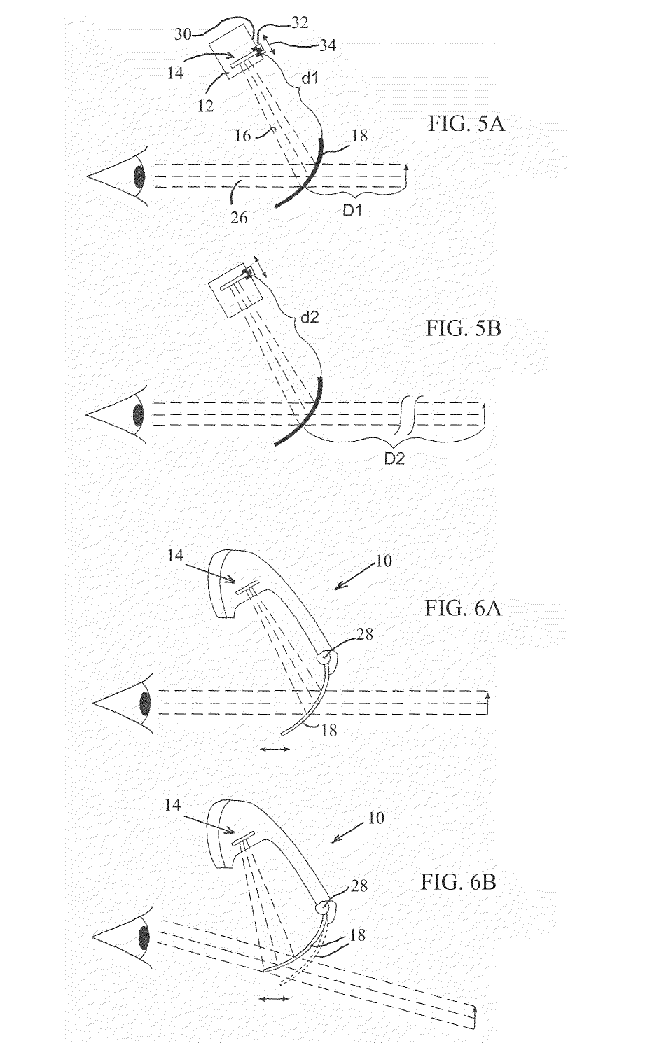

Reference is now made to FIGS. 5A-5B, which illustrate the adjustment capabilities of HMD 10, as described in U.S. patent application Ser. No. 12/348,919, the disclosure of which is incorporated herein by reference. Optics module 14 is movably mounted in housing 12, such that the focal distance of the beam 16 to display substrate 18 may be adjusted by the user. In a preferred embodiment, the focal distance of a lens of optics module 14 is fixed, and the image source is moved so as to change the distance of the imaginary image as viewed by the user. For example, optics module 14 may be mounted on a track 30 formed in housing 12 and a knob 32 may be grasped by the user to move optics module 14 in the direction of arrows 34. In FIG. 5A, a reference distance d1 is the distance between optics module 14 and a reference point on display screen 18. Corresponding to this setting, the user sees the displayed images along an optical path 26 at a certain virtual distance. D1 denotes a reference distance from some reference point on display screen 18 to where the images are seen. In FIG. 5B, the user has moved optics module 14, and there is now a new reference distance d2 corresponding to a different (longer) virtual distance with a new (longer) distance D2.

Accordingly, HMD 10 provides the capability for the user to set the image at any desired virtual distance, such as from 20 cm to infinity. HMD 10 places the image at a convenient viewing position and eliminates the need for refocus and the delay associated with it. It is noted that “infinity virtual distance” is the distance at which the viewing eye sees the object with relaxed focus. This distance may be 20 m or more.

Accordingly, the HMD 10 may be constructed as a monochromic and monocular HMD with interchangeable display screens 18 for displaying images in different colors while maintaining high transparency. HMD 10 may be constructed as an augmented monochromatic, high contrast outdoor head mounted display with a very small form factor, and having power efficient illumination and back lighting technology.

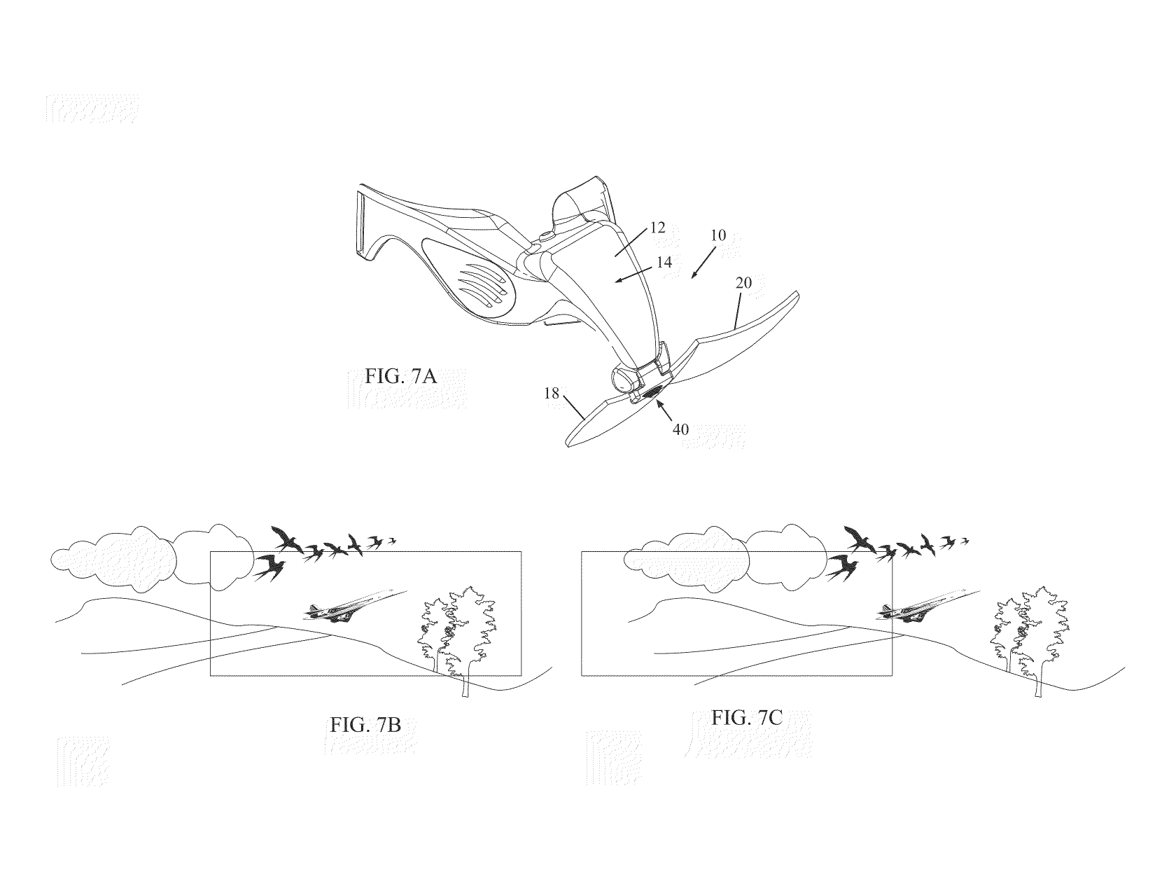

Reference is now made to FIGS. 7A-7C, which illustrate a tracking capability of HMD 10, in accordance with a non-limiting embodiment of the present invention. HMD 10 may be provided with a camera 40 in communication with optics module 14. Camera 40 may be used to provide the user with a feeling of objects moving across and off the screen 18 out to the background. For example, it is seen in FIG. 7B that a flock of birds and an airplane are flying across the screen. If the user's head moves to the left, the camera 40 will detect the movement and send a signal to the processing portion of optics module 14 to cause the birds and airplane to be displayed shifted to the right. Other sensors instead of or in addition to camera 40 may be used, such as but not limited to, an accelerometer.

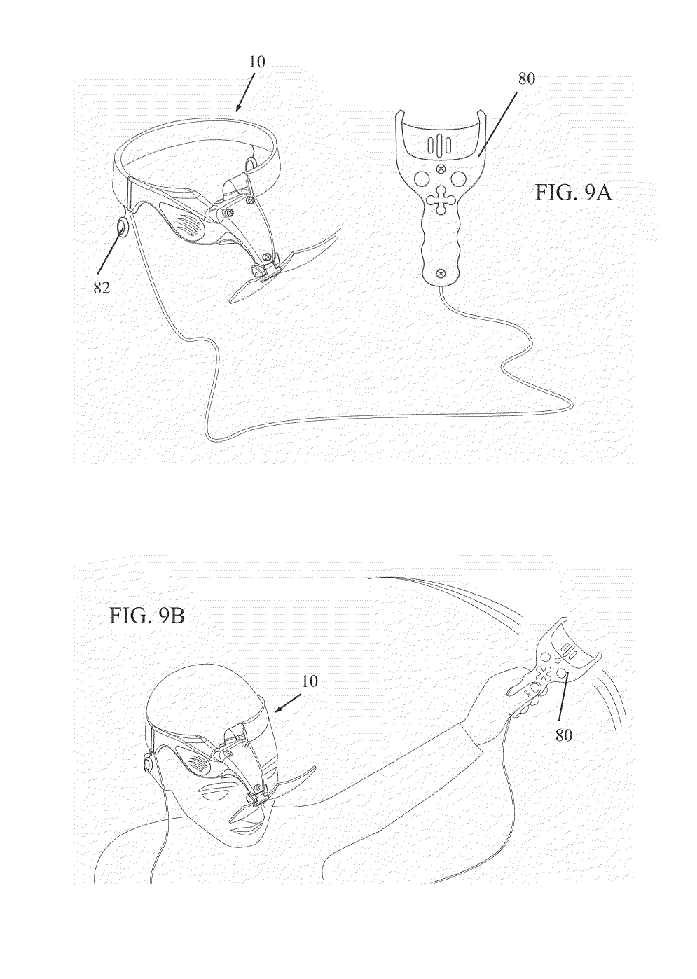

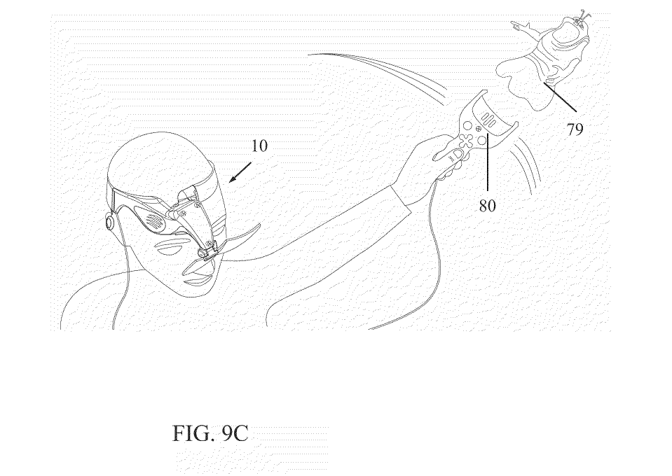

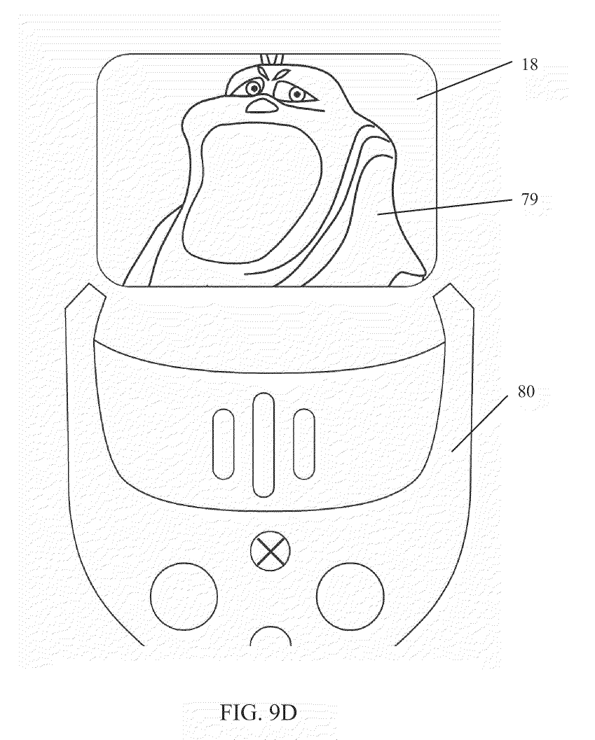

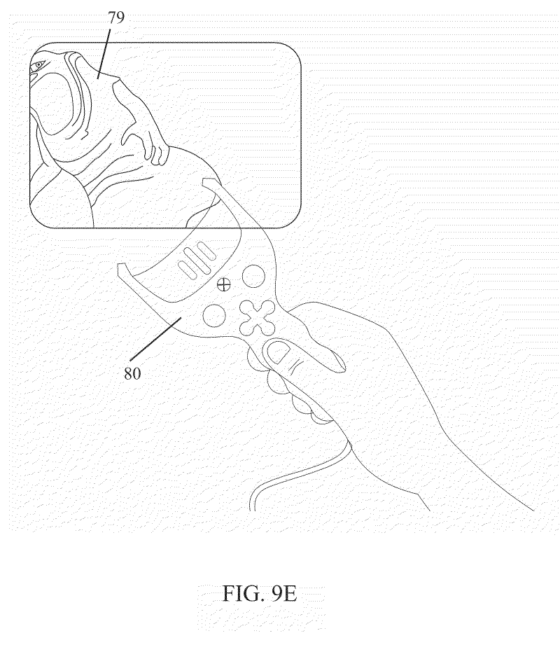

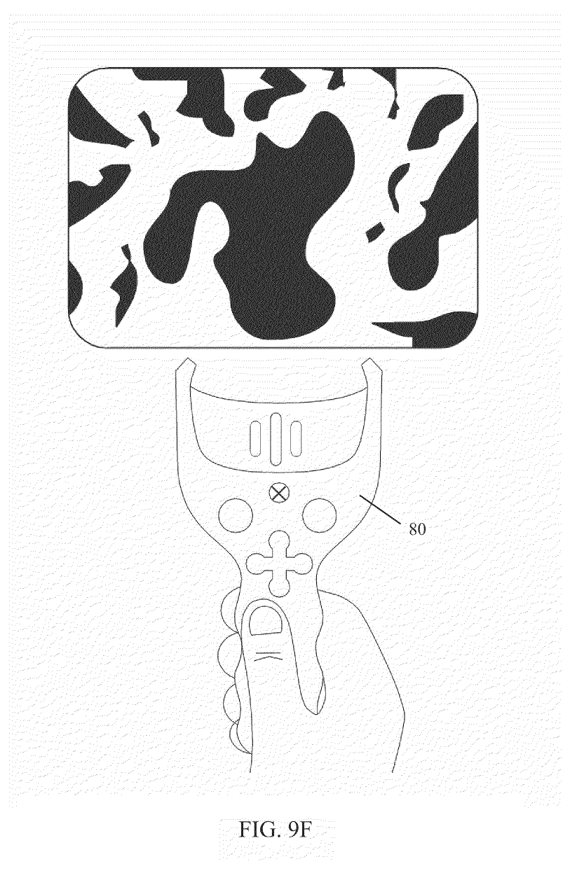

Reference is now made to FIGS. 9A-9F, which illustrate a game which may be played with HMD 10, in accordance with a non-limiting embodiment of the present invention. The game involves catching a ghost, as is explained below.

HMD 10 in this embodiment is used as a head unit to view a ghost 79 (FIG. 9C), that is, both eyes see the background while one eye sees an image of a ghost on the display screen superimposed on the background, as explained above. The controller in this embodiment includes a hand held unit 80 (FIGS. 9A-9B), also referred to as a sniffer/holder/blaster. HMD 10 may be further provided with stereo ear buds 82. (The design of the ghost and other images may be of characters that are licensed property.)

In the non-limiting embodiment, the head unit includes three microphones (ultrasonic) and the hand unit two ultrasonic emitters, for sensing six degrees of freedom of the position of the hand unit relative to the viewing area. Alternatively, any other tracking method can be used, such as accelerometers, earth magnetic field sensing (3D) and others or combination thereof.

The game play scenario projected by the head unit (the optics module) can be adapted to create random movements of ghosts including surrounding stereo voices (created by audio devices), thereby creating an effect of ghosts floating around independently in the room without the need for registration to the environment. This provides significant cost savings in such a system by obviating the need for expensive registration systems.

The game can have many possibilities. For example, by clicking a “stun” button on the controller, the player can “catch the ghost” (FIG. 9D). Successful catching of the ghost can be signaled by the hand controller emitting a distinctive sound, e.g., a rapid sound like a Geiger counter. Upon catching the ghost (by the appropriate sound detection or by hitting or stunning the ghost when it enters the field of view, which may have crosshairs, accompanied with sparks or other theatrical effects, etc.), the ghost becomes “attached” to the controller top, which is tracked via the three microphones and two ultrasound emitters.

As mentioned above, the player sees the ghost only via the viewer lens so when the controller is in front of the player and its orientation and position in the 3D space is determined by the sensors, the ghost image will track the hand controller orientation (FIG. 9E). The player can manipulate the sniffer to morph the ghost by different control buttons, such as shrinking, zapping or freeing the ghost (if it is a good ghost) (FIG. 9F). Everything is seen via the special viewer display which is head mounted on the player.

When the hand device is close to the face of the player a large image of the ghost will be seen; when the hand device is moved away and tilted, the image of the ghost becomes smaller and tilted, too. The manipulations have six degrees of freedom. The type of manipulation is in the game play. If the player decides to “evaporate” the ghost or any other game step, the ghost will follow in space with the hand device until execution of the game step.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A head mounted display (HMD) comprising:
a display screen attached to a housing and aligned to be in a line of sight of a first eye of a user;
an optics module disposed in said housing, for generating an image and projecting a beam of said image on said display screen; and
a non-display screen attached to said housing and aligned to be in a line of sight of a second eye of the user, wherein said image displayed on said display screen is displayed at a virtual display distance different than a distance at which an image of said non-display screen is perceived.

2. The HMD according to claim 1, wherein said display screen displays said image superimposed upon the image of said non-display screen.

3. The HMD according to claim 1, wherein said display screen and said non-display screen have similar light transmissivity.

4. The HMD according to claim 1, wherein said display screen and said non-display screen have similar light transmissivity and said display screen has a greater reflectivity than said non-display screen.

5. The HMD according to claim 1, wherein said non-display screen is darker than said display screen.

6. The HMD according to claim 1, wherein said non-display screen has similar optical reflectivity and transmission as said display screen.

7. The HMD according to claim 1, wherein said non-display screen has different optical reflectivity and transmission than said display screen.

8. The HMD according to claim 1, wherein a position of said beam with respect to said optics module to said display screen is adjustable so as to adjust said virtual distance at which said image is seen.

9. The HMD according to claim 1, wherein said optics module is movably mounted in said housing, such that a distance of said optics module to said display screen is adjustable.

10. The HMD according to claim 1, wherein said display screen is pivotally mounted to said housing by means of a hinge.

11. The HMD according to claim 1, further comprising a sensor in communication with said optics module, said sensor operative to sense movement of the user to provide the user with a feeling of objects moving across and off said display screen.

12. The HMD according to claim 11, wherein said sensor comprises a camera.

13. The HMD according to claim 1, further comprising sensors and controls to manipulate said image in communication with said optics module, said sensors operative to sense movement of the user to provide the user with a feeling of objects moving across and off said display screen.

14. The HMD according to claim 1, wherein said optics module creates random movements of images and audio devices create stereo sounds, thereby creating an effect of images floating around independently in surroundings without need for registration to the surroundings.
